(19) United States
(12) Patent Application Publication
(10) Pub. No.: US 2020/0344111 A1
(43) Pub. Date: Oct. 29, 2020

(54) SYSTEM AND METHOD FOR OBTAINING CONSENSUS IN A DISTRIBUTED LEDGER NETWORK

(71) Applicant: Rani MALHOTRA, Karnataka (IN)

(72) Inventor: Rani MALHOTRA, Karnataka (IN)

(21) Appl. No.: 16/924,260

(22) Filed: Jul. 9, 2020

(30) Foreign Application Priority Data
May 14, 2020 (IN) 202041020393

(51) Int. Cl. H04L 12/24; H04L 9/06; H04L 29/06

(52) U.S. Cl. CPC H04L 41/044; H04L 9/0637; H04L 2209/38; H04L 63/12; H04L 41/12

(57) ABSTRACT

Systems and methods are provided for obtaining consensus on an event between nodes of a network. The event related to a transaction on a distributed ledger is detected, where the transaction is initiated by a first node of said network and the first node has a unique identifier associated therewith. The transaction is mapped to said unique identifier to indicate source of said transaction. At least one validation node is identified which is capable of governing and/or validating said transaction. Then a pluggable consensus is obtained on transaction, using said at least one validation node. The pluggable consensus is obtained using a consensus mechanism selected from a plurality of pre-stored consensus mechanisms, where the selection is performed based on security and throughput attributes extracted from said transaction.

### FIELD OF THE INVENTION

The present disclosure generally relates to distributed ledger network and more particularly, related to obtaining consensus between nodes of the distributed ledger network.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

A distributed ledger network includes a distributed database characterized by securely sharing data exchanged between a plurality of institutions. Each of such institution may include a set of nodes sharing the same data set. The distributed ledger technology may be implemented in different forms such as IOTA, directed acyclic graphs (DAGs), blockchain, and so on. In the distributed ledger network, interaction e.g., transaction is consented by at least those nodes that are participants in the transaction as well as at least one node responsible for governance and then the contents of the ledger are synchronized. Therefore, obtaining consensus between nodes is an intrinsic feature of the distributed ledgers. In this manner, an enterprise may interact with multiple institutions. In such type of interactions, following essential factors need to be considered for effective communications—privacy, speed, throughput, and security. Such interactions, e.g., transaction or resource transfer, may be performed at local level, regional level, and global level. The interaction at local level may be limited to a particular geographical area such as intracity and intercity, whereas the interaction at global level may include interactions between different nation states or associations of nation states groups. The interactions at regional level may be limited to a particular region that may be defined based on formally defined groups such as economic coalitions. However, in order to collaborate interactions at either of local, regional, and global levels, there is a need to obtain consensus between different entities. In addition, with the existing systems, process involved in collaboration poses a problem of reconciling security and throughput in heterogeneous (e.g., subsidiary network of an institution) and homogeneous networks (e.g., branch network of an institution). In some cases, need of flexibility to trade one for the other may be raised.

Existing distributed ledger technologies (DLTs) provide consensus mechanisms between nodes of these multi-level enterprise networks. However, each DLT is associated with a particular consensus mechanism. As the DLT being specific to a consensus mechanism, certain types of interaction such as transaction between nodes of the distributed ledger network suffers from poor performance, which results in higher cost and speed overheads. In addition, such interactions may be prone to cyberattack, which causes a lot of damage to valuable and sensitive information.

Thus, there is a need for system and method that deploy the appropriate consensus mechanism based on various criteria associated with type of interactions.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

### OBJECTS OF THE INVENTION

A general object of the present disclosure is to provide an efficient mechanism to deploy consensus algorithms depending on the context of transactions.

An object of the present disclosure is to provide a system for obtaining consensus between different nodes of the network reconciling privacy and security, thereby enabling effective communications.

An object of the present disclosure is to provide a system that can reconcile security and throughput in both heterogeneous (e.g., subsidiary network of an institution) and homogeneous networks (e.g., branch network of an institution).

An object of the present disclosure is to provide a system that reduces operational overheads i.e. cost and time involved in resource exchange and provides flexibility in reconciling security and throughput in accordance with transaction contexts, thereby facilitating efficient processing of transactions.

An object of the present disclosure is to provide a platform where the different nodes can interact with each other, thereby enabling resource exchange at global level (e.g., different nation states or associations of nation states groups) and/or regional level (formally defined groups such as economic coalitions) and/or local level (e.g., intracity and intercity).

### SUMMARY

The present disclosure generally relates to distributed ledger network and more particularly, related to obtaining consensus between nodes of a distributed ledger network.

An aspect of the present disclosure pertains to a system for obtaining consensus on an event between nodes of a network, said system being configured in at least one network device having a processor, said processor, through execution of instructions stored in an operatively coupled memory, being configured to: detect that said event relates to a transaction on a distributed ledger that is configured over said network, said transaction being initiated by a first node of said network, said first node having a unique identifier associated therewith, wherein the transaction is mapped to said unique identifier to indicate source of said transaction; identify, from amongst the nodes of said network, at least one validation node capable of governing and/or validating said transaction; and obtain, using said at least one validation node, pluggable consensus on said transaction, said pluggable consensus being obtained using a consensus mechanism selected from plurality of pre-stored consensus mechanisms, said selection being done based on security and throughput attributes extracted from said transaction.

According to an embodiment, said consensus mechanism is selected from any or a combination of BFT, PBFT, BFT-SMaRT, HotStuff, and SMR.

According to an embodiment, said at least one validation node is identified based on geographical attributes associated with said transaction.

According to an embodiment, said at least one validation node is identified based on volume of transactions initiated by said source, or volume of transactions that said source is part of.

According to an embodiment, said at least one validation node is identified based on a number of nodes that form part of, or get impacted by said transaction.

According to an embodiment, said at least one validation node is identified based on trust between nodes that form part of said transaction.

According to an embodiment, said at least one validation node is selected from a plurality of validation nodes configured in the network, said plurality of validation nodes being configured in a hierarchical architecture so as to be used to validate/govern a plurality of transactions based on attributes of said transactions.

Another aspect of the present disclosure relates to a method for obtaining consensus on an event between nodes of a network, said method comprising the steps of: detecting, at a computing device that forms part of said network, that said event relates to a transaction on a distributed ledger that is configured over said network, said transaction being initiated by a first node of said network, said first node having a unique identifier associated therewith, wherein the transaction is mapped to said unique identifier to indicate source of said transaction; identifying, from amongst the nodes of said network, at least one validation node capable of governing and/or validating said transaction; and obtaining, using said at least one validation node, pluggable consensus on said transaction, said pluggable consensus being obtained using a consensus mechanism selected from plurality of pre-stored consensus mechanisms, said selection being done based on security and throughput attributes extracted from said transaction.

According to an embodiment, said consensus mechanism is selected from any or a combination of BFT, PBFT, BFT-SMaRT, HotStuff, and SMR.

According to an embodiment, said at least one validation node is identified based on geographical attributes associated with said transaction.

According to an embodiment, said at least one validation node is identified based on volume of transactions initiated by said source, or volume of transactions that said source is part of.

According to an embodiment, said at least one validation node is identified based on a number of nodes that form part of, or get impacted by said transaction.

According to an embodiment, said at least one validation node is identified based on trust/security between nodes that form part of said transaction.

According to an embodiment, said at least one validation node is selected from a plurality of validation nodes configured in the network, said plurality of validation nodes being configured in a hierarchical architecture so as to be used to validate/govern a plurality of transactions based on attributes of said transactions.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

FIG. 1 indicates a network implementation of a system for obtaining a consensus between nodes, in accordance with an embodiment of the present disclosure.

FIG. 2 illustrates an exemplary representation of a peer-to-peer (P2P) distributed network, in accordance with embodiments of the present disclosure.

FIG. 3 illustrates an exemplary representation of a distributed ledger network, in accordance with embodiments of the present disclosure.

FIG. 4 illustrates an exemplary representation of services executed in a distributed ledger network, in accordance with embodiments of the present disclosure.

FIG. 5 illustrates an exemplary representation of hierarchical structure of P2P distributed network, in accordance with embodiments of present disclosure.

FIG. 6 illustrates exemplary functional components of the system, in accordance with an embodiment of the present disclosure.

FIG. 7 illustrates an exemplary method for obtaining an consensus between nodes in a network, in accordance with an embodiment of the present disclosure.

FIG. 8 illustrates an exemplary computer system to implement the proposed system, in accordance with embodiments of the present disclosure.

### DETAILED DESCRIPTION

In the following description, numerous specific details are set forth in order to provide a thorough understanding of embodiments of the present invention. It will be apparent to one skilled in the art that embodiments of the present invention may be practiced without some of these specific details.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

The present disclosure generally relates to distributed ledger network and more particularly, related to obtaining consensus between nodes of the distributed ledger network.

An aspect of the present disclosure pertains to a system for obtaining consensus on an event between nodes of a network, said system being configured in at least one network device having a processor, said processor, through execution of instructions stored in an operatively coupled memory, being configured to: detect that said event relates to a transaction on a distributed ledger that is configured over said network, said transaction being initiated by a first node of said network, said first node having a unique identifier associated therewith, wherein the transaction is mapped to said unique identifier to indicate source of said transaction; identify, from amongst the nodes of said network, at least one validation node capable of governing and/or validating said transaction; and obtain, using said at least one validation node, pluggable consensus on said transaction, said pluggable consensus being obtained using a consensus mechanism selected from plurality of pre-stored consensus mechanisms, said selection being done based on security and throughput attributes extracted from said transaction.

According to an embodiment, said consensus mechanism may be selected from any or a combination of BFT, PBFT, BFT-SMaRT, HotStuff, and SMR.

According to an embodiment, said at least one validation node may be identified based on geographical attributes associated with said transaction.

According to an embodiment, said at least one validation node may be identified based on volume of transactions initiated by said source, or volume of transactions that said source is part of (See Table 1).

According to an embodiment, said at least one validation node may be identified based on a number of nodes that form part of, or get impacted by said transaction.

According to an embodiment, said at least one validation node may be identified based on trust between nodes that form part of said transaction.

According to an embodiment, said at least one validation node may be selected from a plurality of validation nodes configured in the network, said plurality of validation nodes being configured in a hierarchical architecture so as to be used to validate/govern a plurality of transactions based on attributes of said transactions.

Another aspect of the present disclosure relates to a method for obtaining consensus on an event between nodes of a network, said method comprising the steps of: detecting, at a computing device that forms part of said network, that said event relates to a transaction on a distributed ledger that is configured over said network, said transaction being initiated by a first node of said network, said first node having a unique identifier associated therewith, wherein the transaction is mapped to said unique identifier to indicate source of said transaction; identifying, from amongst the nodes of said network, at least one validation node capable of governing and/or validating said transaction; and obtaining, using said at least one validation node, pluggable consensus on said transaction, said pluggable consensus being obtained using a consensus mechanism selected from plurality of pre-stored consensus mechanisms, said selection being done based on security and throughput attributes extracted from said transaction.

According to an embodiment, said consensus mechanism may be selected from any or a combination of BFT, PBFT, BFT-SMaRT, HotStuff, and SMR.

According to an embodiment, said at least one validation node may be identified based on geographical attributes associated with said transaction.

According to an embodiment, said at least one validation node may be identified based on volume of transactions initiated by said source, or volume of transactions that said source is part of.

According to an embodiment, said at least one validation node may be identified based on a number of nodes that form part of, or get impacted by said transaction.

According to an embodiment, said at least one validation node may be identified based on trust/security between nodes that form part of said transaction.

According to an embodiment, said at least one validation node may be selected from a plurality of validation nodes configured in the network, said plurality of validation nodes being configured in a hierarchical architecture so as to be used to validate/govern a plurality of transactions based on attributes of said transactions.

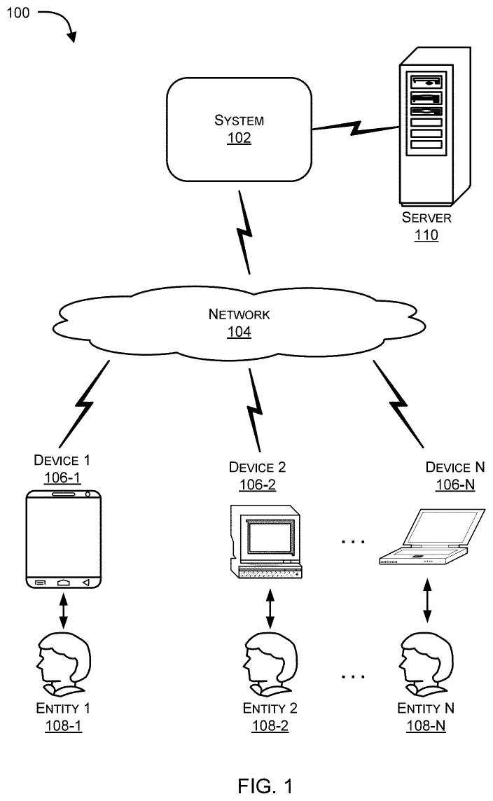

FIG. 1 indicates a network implementation 100 of a system for obtaining a consensus between nodes, in accordance with an embodiment of the present disclosure.

According to an embodiment of the present disclosure, a system (also referred to as the system 102, hereinafter) can facilitate obtaining a consensus based on an event being occurred between nodes of a network. The system 102 implemented in any computing device can be configured/operatively connected with a server 110. The system 102 can be configured in at least one network device. As illustrated, the system 102 can be communicatively coupled with one or more entity devices 106-1, 106-2, . . . , 106-N (individually referred to as the entity device 106 and collectively referred to as the entity devices 106, hereinafter) through a network 104. The one or more entity devices 106 are connected to the living subjects/users/entities 108-1, 108-2, . . . , 108N (individually referred to as the entity 108 and collectively referred to as the entities 108, hereinafter). The entity devices 106 (also referred to as computing device 106) can include a variety of computing systems, including but not limited to, a laptop computer, a desktop computer, a notebook, a workstation, a portable computer, a personal digital assistant, a handheld device and a mobile device. In an embodiment, the system 102 can be implemented using any or a combination of hardware components and software components such as a cloud, a server, a computing system, a computing device, a network device and the like. Further, the system 102 can interact with the entity devices 106 through a website or an application that can reside in the entity devices 106. In an implementation, the system 102 can be accessed by a website or application that can be configured with any operating system, including but not limited to, Android™, iOS™, and the like. Examples of the computing devices 106 can include, but are not limited to, a computing device associated with industrial equipment or an industrial equipment based asset, a smart camera, a smart phone, a portable computer, a personal digital assistant, a handheld device and the like.

Further, the network 104 can be a wireless network, a wired network or a combination thereof that can be implemented as one of the different types of networks, such as Intranet, Local Area Network (LAN), Wide Area Network (WAN), Internet, and the like. Further, the network 104 can either be a dedicated network or a shared network. The shared network can represent an association of the different types of networks that can use variety of protocols, for example, Hypertext Transfer Protocol (HTTP), Transmission Control Protocol/Internet Protocol (TCP/IP), Wireless Application Protocol (WAP), and the like.

In an embodiment, the system 102 can facilitate resource exchange between nodes of the network. In an embodiment, the resource may include any or a combination of currency, product, service, and so on. The network may include multiple nodes such as global nodes, local nodes, regional nodes, and so on. One or more of the multiple nodes may have authority to validate/verify or allow the consensus to execute.

Embodiments of the present disclosure may be implemented on a distributed ledger system (DLS) or in a distributed ledger network in which transaction may be performed between different nodes of the network, where the node may also refer to the entity. The DLS system can be referred to as a consensus network that maintains a distributed ledger that is consensually shared and synchronized across multiple institutions. The consensus network may be implemented as peer-to-peer nodes and may enable entities to perform secure and immutable transactions. The obtained consensus between nodes of the network may facilitate transaction between multiple users, where such transaction information is consensually shared and synchronized between different nodes of the distributed ledger network. Thus, system 102 enables secured transactions through consensus management between different institutions/enterprises. In some embodiment, the system enables a consensus to be proposed, modified, executed. In another embodiment, each enterprise may host one or more nodes in the network according to the consensus. In this way, a private and secure connection may be established between the enterprises using the network.

In an embodiment, the system 102 can communicate with the entity devices via a low point-to-point communication protocol such as Bluetooth®. In other embodiments, the system may also communicate via other various protocols and technologies such as WiFi®, WiMax®, iBeacon®, and near field communication (NFC). In other embodiments, the system 102 may connect in a wired manner to entity devices. Examples of the entity devices may include, but are not limited to, computer monitors, television sets, light-emitting diodes (LEDs), and liquid crystal displays (LCDs).

Although in various embodiments, the implementation of system 102 is explained with regard to the server 110, those skilled in the art would appreciate that, the system 102 can fully or partially be implemented in other computing devices operatively coupled with network 104 such as entity devices 106 with minor modifications, without departing from the scope of the present disclosure.

In an embodiment, one or more nodes of the network may have to register with the system. The registration process may require identification information such as name, member state, regulation of that state, and so on.

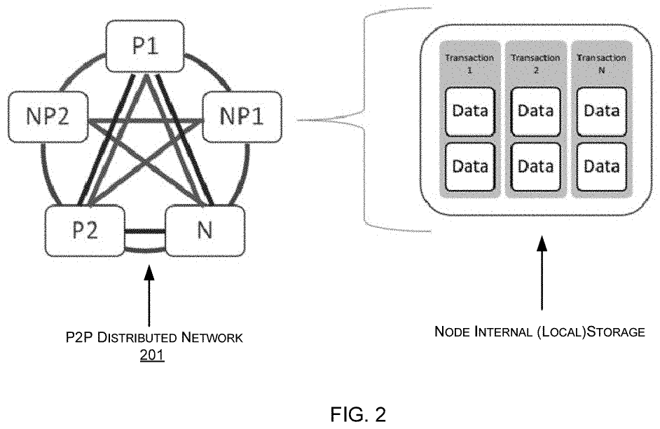

FIG. 2 illustrates an exemplary representation of a peer-to-peer (P2P) distributed network, in accordance with embodiments of the present disclosure. As illustrated in FIG. 2, there may be three type of nodes in a P2P distributed network 201—participant node (P), non-participant node (NP), and validation node (N). In an example, the P2P distributed network can be operated by an institution that may be connected to a similar type of network. All the nodes of the P2P distributed network may be connected to each other, however, during a session, few nodes may participate in the transaction, which may be referred to as participant nodes. The validation nodes may be capable of governing/validating the transaction. In an exemplary embodiment, selection of the validation node may depend upon the type of session. In an example, for different sessions, the validation nodes may be different or may be the same. In an embodiment, the P2P distributed network may include non-validation node(s) that may not be capable of governing the transaction but can participate in the transaction. The non-validation node(s) can be either participant node or non-participant node. In an embodiment, the participant nodes in a session may be non-participant nodes in another session. In an exemplary embodiment, the selection of the participant and non-participant node may depend on type of transaction.

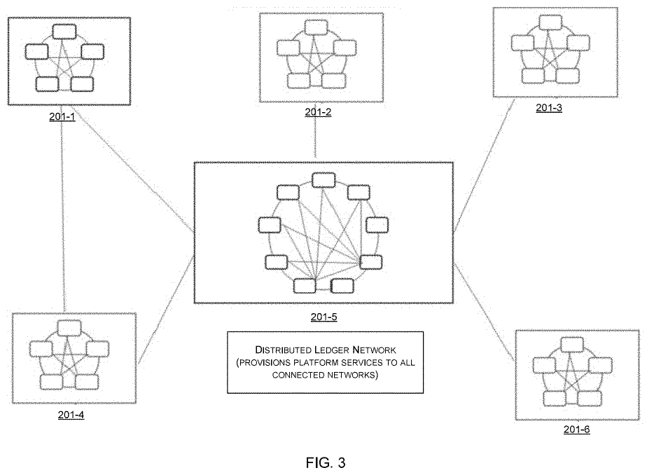

FIG. 3 illustrates an exemplary representation of a distributed ledger network, in accordance with embodiments of the present disclosure. As illustrated in FIG. 3, different P2P distributed network 201-1, 201-2, 201-3, 201-4, 201-5, and 201-6 (collectively referred to as distributed ledger networks 201 or individually referred to as distributed ledger network 201) may be connected through a distributed ledger platform. In order to execute their respective process and/or to obtain a service from one or more P2P distributed networks, the P2P distributed network 201 may be connected to each other in the distributed ledger network. In other words, the P2P distributed networks that require similar types of services may connect to each other and form the distributed ledger network. Thus, the distributed ledger network/platform may provision services to one or more of the connected P2P distributed networks. In an exemplary embodiment, each of such P2P distributed networks may be owned by one or more institutions that are different to each other.

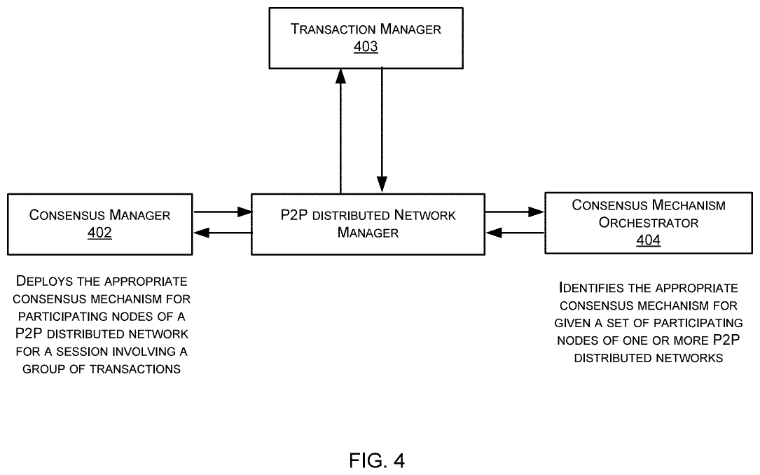

FIG. 4 illustrates an exemplary representation of services executed in a distributed ledger network, in accordance with embodiments of the present disclosure. In the distributed ledger network, a P2P distributed network manager 401 may be provided which communicates with different types of services such as a consensus manager 402, transaction manager 403, and consensus mechanism orchestrator 404. The P2P distributed network manager 401 may determine a set of services to be provided to one or more P2P distributed networks. In an embodiment, the consensus manager 402 may be configured to deploy an appropriate consensus mechanism for participating nodes of a P2P distributed network for a session involving a group of transactions, whereas the transaction manager 402 may be configured to manage the transactions between the participating nodes of one or more P2P distributed network during a session. In another embodiment, the consensus mechanism orchestrator 404 may be configured to obtain a pluggable consensus for given a set of participating nodes of one or more P2P distributed networks and for a particular session. The pluggable consensus being obtained using a consensus mechanism that may be selected from a set of consensus mechanisms, where the selection is performed based on security and throughput attributes extracted from said transaction.

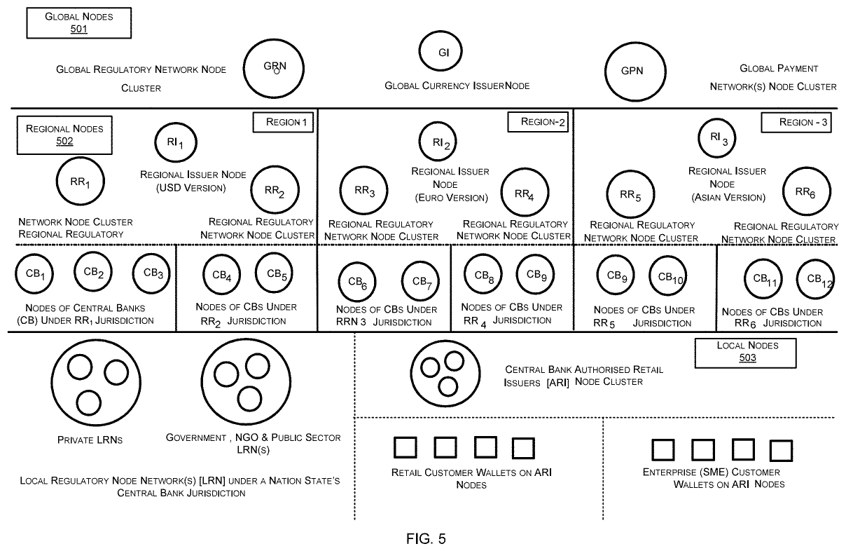

FIG. 5 illustrates an exemplary representation of hierarchical structure of P2P distributed network, in accordance with embodiments of present disclosure. As illustrated in FIG. 5, P2P distributed network may be categorized into global nodes 501, regional nodes 502, and local nodes 503. The P2P distributed network 500 may be categorized based on a defined set of rules such as currency jurisdiction, geo-political jurisdiction. In an example, the global nodes 501 may include but not limited to a global regulatory network node, a global currency issuer node such as IMF and world bank, a global payment network node cluster such as Visa, Mastercard. In an exemplary embodiment, the global currency issuer node may be operated by an institution such as Bank for International Settlements (BIS). In an embodiment, the global currency issuer node may decide one resource type for each of the region-1, region-2, and region-3, where in each of the region, flow of resources is regulated by the regional nodes. In an exemplary embodiment, these regions may be based on formally defined groups such as economic coalitions—either within an economic coalition or between the different economic coalitions. In each region, there is a regional issuer node that regulates the resource type in their respective region. The regional nodes may be further divided into sub-regions such as RR₁, RR₂ based on jurisdiction. Such nodes may regulate the flow of resources in their respective regional nodes such as CB₂, CB₃. The local nodes 503 may include Private LRN, government, NGOs, and Public sector LRN(s). Thus, the network may have a different type of node, each type of node may have a defined set of rules or set of rights for authorization. In an exemplary embodiment, when the event associated with a transaction is detected between the local nodes, then the throughput/speed may be considered as primary criterion to select the consensus mechanism. In another exemplary embodiment, when the event associated with a transaction is detected between the global and regional node, then the security may be taken as primary criterion in selection of an appropriate consensus mechanism. Thus, FIG. 5 illustrates the scenario where the effective consensus mechanism as proposed, can be applied based on various criterion to obtain a pluggable consensus.

In an exemplary embodiment, the local nodes may be segregated into following types:
Level 1—Intra City—refers to interactions on the ledger between nodes operated by institutions that are under the same fiscal jurisdiction as well as state & city jurisdictions.]
Level 2a—Inter City—refers to interactions on the ledger between nodes operated by institutions that are under the same fiscal jurisdiction as well as state jurisdiction, but different city jurisdictions
Level 2b—Inter City—refers to interactions on the ledger between nodes operated by institutions that are under the same fiscal jurisdiction but different state jurisdictions.

In an exemplary embodiment, the regional nodes may be segregated into following types:
Level 1: Intra-Regional—refers to interactions on the ledger between nodes operated by institutions that are under the fiscal jurisdiction of geographical entities (like countries) that are members of a formally defined group (like an economic coalition.)
Level 2a: Inter-Regional—refers to interactions on the ledger between nodes operated by institutions that are under the fiscal jurisdiction of geographical entities (like countries), that are members of different formally defined groups of the same type (like different economic coalitions) i.e. Regions, but are part of at-least one super-group together (for example, both the economic coalitions are under the same regional currency jurisdiction).
Level 2b: Inter-Regional—refers to interactions on the ledger between nodes operated by institutions that are under the fiscal jurisdiction of geographical entities (countries), that are members of different formally defined groups of the same type (like different economic coalitions or Regions), and are also part of at-least one mutually exclusive super-group (for example, when both the economic coalitions are under different regional currency jurisdiction).

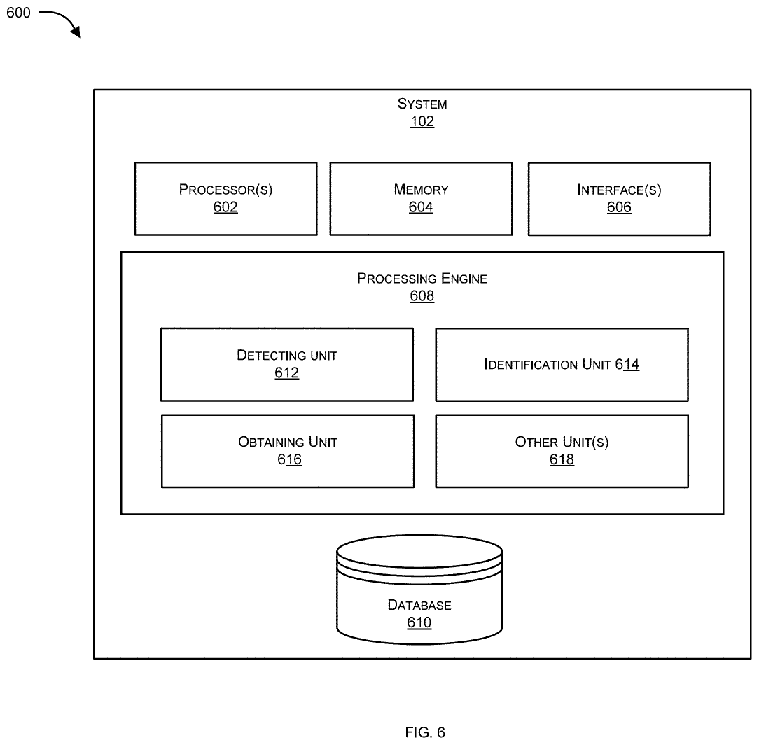

FIG. 6 illustrates exemplary functional components 600 of the system 102 in accordance with an embodiment of the present disclosure.

In an aspect, the system 102 may comprise one or more processor(s) 602. The one or more processor(s) 602 may be implemented as one or more microprocessors, microcomputers, microcontrollers, digital signal processors, central processing units, logic circuitries, and/or any devices that manipulate data based on operational instructions. Among other capabilities, the one or more processor(s) 602 are configured to fetch and execute computer-readable instructions stored in a memory 604 of the system 102. The memory 604 may store one or more computer-readable instructions or routines, which may be fetched and executed to create or share the data units over a network service. The memory 604 may comprise any non-transitory storage device including, for example, volatile memory such as RAM, or non-volatile memory such as EPROM, flash memory, and the like.

The system 102 may also comprise an interface(s) 606. The interface(s) 606 may comprise a variety of interfaces, for example, interfaces for data input and output devices, referred to as I/O devices, storage devices, and the like. The interface(s) 606 may facilitate communication of the system 102 with various devices coupled to the system 102 such as an input unit and an output unit. The interface(s) 606 may also provide a communication pathway for one or more components of the computing device 102. Examples of such components include, but are not limited to, processing engine(s) 608 and database 610.

The processing engine(s) 608 may be implemented as a combination of hardware and programming (for example, programmable instructions) to implement one or more functionalities of the processing engine(s) 608. In examples described herein, such combinations of hardware and programming may be implemented in several different ways. For example, the programming for the processing engine(s) 608 may be processor executable instructions stored on a non-transitory machine-readable storage medium and the hardware for the processing engine(s) 608 may comprise a processing resource (for example, one or more processors), to execute such instructions. In the present examples, the machine-readable storage medium may store instructions that, when executed by the processing resource, implement the processing engine(s) 608. In such examples, the computing device 102 may comprise the machine-readable storage medium storing the instructions and the processing resource to execute the instructions, or the machine-readable storage medium may be separate but accessible to the system 102 and the processing resource. In other examples, the processing engine(s) 608 may be implemented by electronic circuitry. The database 610 may comprise data that is either stored or generated as a result of functionalities implemented by any of the components of the processing engine(s) 608.

In an exemplary embodiment, the processing engine(s) 608 may comprise detecting unit 612, identification unit 614, obtaining unit 616, and other units(s) 618.

It would be appreciated that units being described are only exemplary units and any other unit or sub-unit may be included as part of the system 102. These units too may be merged or divided into super-units or sub-units as may be configured.

In an embodiment, the entity can enroll with the system 102 by completing a registration process. The registration process can be defined for limiting use of services by the system. As an example, the service can be limited to the entities of a particular age or a business type and so forth. For the registration process, the required entity can provide details such as related to name, address, phone number and e-mail address, etc.

### Detecting Unit 612

In an embodiment, the system 102 may be configured to detect an event related to a transaction on a distributed ledger that is configured over the network, whereas the transaction may be initiated by one or more nodes of said network. The nodes can be any one or a combination of global node, regional node, and local node.

In an embodiment, the event may be in the form of a request for resource transaction/exchange that may be received by the system 102. The request may be associated with a transaction initiated by one or more nodes of the network. In another embodiment, the system may assign an identifier to each of the nodes of the network. In an embodiment, one or more nodes may be associated with a plurality of identifiers. In another embodiment, the identifier may be unique for each of the nodes of the network. When the system receives the request, the system may map the transaction associated with the request with identifiers to match the node that has initiated the transaction.

In an embodiment, the identifier can be in the form of a token associated with the nodes of the network. In an exemplary embodiment, the identifier may be configured in any or combination of bar code, RFID tag, QR code, and so on. In an example, the identifier may be configured as any or a combination of alphabets, numbers, and special characters such as but not limited to ABC214, 124QWF, DFE@3 and so on. The identifier may include personal identification information such as name, location/region and so on. The identifier being associated with the nodes may allow the system to determine a source from which the request has been received.

In an embodiment, the system 102 may receive multiple requests that may be associated with different types of resources, where the request can be considered as an event associated with a transaction. The requests associated with a particular resource type may be aggregated in one pool. In an exemplary embodiment, first and second request pools may be associated with a first resource type and a second resource type. In an example, for all the requests associated with service type 1, a first request pool RP1 may be maintained and for all the requests associated with a service type 2, a second request pool RP2 may be maintained. In an embodiment, the request may be aggregated at the system 102. The aggregation of the request or request pool may be based on various criteria such as but not limited to:
Number of requests in each request pool may be the same.
In a particular time window, a fixed number of requests (assume m) are allowed. If the number of requests in a defined time window (say T1-T2) exceeds the fixed number m (or are left over due to Request Pool Size constraints], the leftover request may be considered to the next time window (say T2-T3), where the T1, T2, and T3 are considered at three different time instances such that T1<T2<T3. e.g., Consider the following requests of each currency type (Type 1: R1, Type 2: R2, Type 3: R3) in a time window T1-T2, where the requestor may be considered as a, b, c, d.

| | | | | | | | |
|---|---|---|---|---|---|---|---|
| t0 | | t1 | | t3 | t2 | t5 | t6 |
| t7 | t8 | | t9 | t10 | t11 | t12 | |
| I | | I | | I | I | I | I |
| I | I | | I | I | I | I | |
| R1ₐ | | R2ₐ | | R1_{b} | R1_{c} | R2_{b} | R3ₐ |
| R2_{c} | R3_{b} | | R3_{c} | R1_{d} | R2_{c} | R2_{d} | |

(Requests in underlined are rolled over to the next window)
No. of requests: 12
Fixed number of request allowing in a particular time window (m): 10
Total No. of request in each resource pool (n): 3
Request Pools for time window [T1-T2]:
RP1=[R1ₐ, R1_{b}, R1_{c}] (R1_{d} rolled over to [T2-T3] since n=3)
RP2=[R2ₐ, R2_{b}] (R2_{c} and R2_{d} rolled over since m=10)
RP3=[R3ₐ, R3_{b}, R3_{c}]
Time windows can be defined/equally distributed over a predefined time period.
Depending on multiple factors, the requests in particular time windows (e.g., time windows associated with the local node or regional node) might be more than the requests in other time windows. Hence the parameter “m” may need to be adjusted manually initially and later on dynamically.

In an embodiment, the request may be received by more than one node in the network. The requests from different nodes may be pooled as a part of the request pool. In such cases, the requests can be redeemed as follows:
a) An acknowledgement signal may be generated for the transaction of resources for all the requests in request pools of each resource type regardless of the nodes from which the request has been received. In an example, the acknowledgement signal may be in form of receipt.
b) After the generating of the acknowledgment signal, transaction of resources can be made successfully by performing either of two steps:
   I. All the requests of each resource type are aggregated and executed together.
   II. When the amount of resource in a request from a request pool of a resource type reaches a threshold, the consensus may be obtained and the request may be executed, where the threshold can be determined based on the parameter m and n as defined above, which can be dynamically set using machine learning after an initial manual adjustments period, thereby improving an efficiency of request aggregation and execution.

In an embodiment, the above request redemption method may be applicable to any one or a combination of global, regional, local nodes, and so on.

### Identification Unit 614

In an embodiment, the system may include an identification unit 614 that may be configured to identify at least one validation node amongst the nodes of the network. In an embodiment, the at least one validation node may be capable of governing and/or validating the transaction. In an embodiment, all or some of the nodes in the network may be categorized in validation nodes and non-validation nodes. In other words, the nodes that are capable of governing/validating, may be already determined and based upon that, the validating and non-validation nodes are determined.

In an embodiment, the validation node can be identified based on geographical attributes such as but not limited to region/location associated with the transaction. Additionally, or alternatively, the validation node can be identified based on volume of transactions initiated by said source, or volume of transactions that said source is part of. In some embodiments, the validation node can be identified based on a number of nodes that form part of, or get impacted by said transaction. In some other embodiments, the validation node may be identified based on trust between nodes that form part of said transaction.

In an embodiment, when the system may not be able to identify the validation node, the system may determine a validation node based on the geographical region of nodes in a network. In particular, the node covering the maximum geographical region may be considered as a validation node.

### Obtaining Unit 616

In an embodiment, upon identification of one or more validation nodes, the obtaining unit may obtain a pluggable consensus. In an exemplary embodiment, the obtaining unit may be implemented as consensus mechanism orchestrator. In an embodiment, the pluggable consensus thus achieved may be replaced with another pluggable consensus having different consensus mechanism, depending upon one or more factors such as request for transaction between nodes. In case when the multiple validation nodes are identified, at least one of the multiple identified validation nodes may be used to obtain a consensus between nodes of the network.

In an embodiment, the consensus may be obtained based on one or more consensus mechanisms. The one or more consensus mechanisms may be selected from a set of consensus mechanisms that may be already stored. In an exemplary embodiment, the set of consensus mechanisms may include but not limited to, any or a combination of BFT, PBFT, BFT-SMaRT, HotStuff, and SMR and so on.

In an embodiment, upon identification of the validation node(s), information associated with the event may be matched with threshold/benchmark criteria and the identification information of one or more nodes may be verified for secure communication.

In an embodiment, the one or more consensus mechanisms may be selected from a plurality of mechanisms based on one or more attributes. Such attributes may include but not limited to, security and throughput. In an embodiment, the attributes may be associated with the transaction to which the detected event is related. In cases where security is a concern, traditional consensus mechanisms such as but not limited to BFT mechanisms may be required to pre-empt network vulnerabilities. Where trust/security is a given, faster mechanisms such as but not limited to RAFT mechanisms can be utilized. In an example, branches of a same branch network with a history of trusted transactions may have throughput as a primary criterion rather than trust/security. Further evaluation criteria could be based on the type of transactions and value/volume of transactions where even if the transactions occur between trusted parties, security cannot be compromised for throughput. Selection of the consensus mechanism can be illustrated as follows: Threshold Transaction Values=T1, T2, T3 where T1>T2>T3

TABLE 1
criteria for selection of consensus mechanisms

| Transaction | | | Non-validation | |
|---|---|---|---|---|
| Type | Conditions | Validation Node | Node | Consensus Mechanism |
| Type 1: Low | Value < T1 | Not required for | Not required | Faster consensus |
| Value | Nodes: Homogeneous | Homogeneous | for | mechanism e.g. RAFT |
| Transactions | network | Network | homogeneous | may be selected |
| | Nodes: Heterogeneous | Interactions' (Straight | transactions. | |
| | network | through Processing | For | |
| | | or STP) | heterogeneous | |
| | | For Heterogeneous | transactions, | |
| | | Interactions, Type 2 | Type 2 | |
| | | (General Category) | (General | |
| | | model is followed, | Category) | |
| | | with few caveats. | model is | |
| | | | followed. | |
| Type 2: | T1 < Value < T2 | (See table 2 for | (See table 3 | Any combination based |
| General | | details) | for details) | mechanism e.g. BFT; or |
| Category | | | | faster mechanism e.g., |
| | | | | RAFT can be deployed |
| | | | | based on the level of |
| | | | | interaction (local, |
| | | | | regional or global) and |
| | | | | the Types of |
| | | | | Interactions as part of a |
| | | | | P2P distributed |
| | | | | network. |
| | | | | e.g. Types 2.1 and 2.3: |
| | | | | Raft or similar |
| | | | | Types 2.2 and 2.4: BFT |
| | | | | or similar |
| Type 3: High | T2 < Value < T3 | Type 2 (General | Type 2 model | Security based |
| Value | Nodes: Any | Category) model is | is followed | consensus mechanism |
| Transactions | | followed. However, | | e g., BFT |
| | | additional | | |
| | | notarization might be | | |
| | | required in some | | |
| | | cases. | | |

TABLE 2
Validation node for General category

| Type of | Level of Nodes | | |
|---|---|---|---|
| Interactions | Local | Regional | Global |
| 2.1 Pₐ₁-Pₐ₂ | Level 2b: At this level, | Level 1: A validation | The Global participant |
| | a validation node could | node could be a node | institution shall be the |
| | be a node operated by | operated by the elected | validation node in these |
| | the elected institution | institution of a region | types of interactions, if |
| | of an industry | wide industry | it is the only institution |
| | consortium (to which | consortium (industry to | of its type among the |
| | Pₐ belongs) with | which Pₐ belongs). | participants. |
| | member institutions | | In the case that there |
| | spread across different | | are multiple global |
| | state jurisdictions (but | | institutions in the P2P |
| | which are under the | | network, each shall |
| | same fiscal | | have a validation node |
| | jurisdiction). | | vote with a weightage, |
| 2.2 Pₐ-P_{b} | Level 2b: A validation | Level 1: Same as 2.1 | based on mutually |
| | node could be a node | Level 2a: A validation | agreed upon criteria. |
| | operated by an elected | node could be a node | Thus the validating |
| | representative of a | operated by elected | authority is distributed |
| | consortium comprising | representatives of | over the network, per |
| | institutions of each | region wide | the weightage granted |
| | type. (The jurisdiction | consortiums in the | to each node's vote. |
| | of these institutions is | transacting regions | |
| | analogous to those for | comprising of | |
| | Type 2.1) | institutions of type | |
| | | (Pₐ, P_{b} and G) | |
| | | Level 2b: Same as | |
| | | Level 2a | |
| 2.3 Pₐ-G | Level 2b: Same as 2.2 | Level 1: Same as 2.1 | |
| | | Level 2a: Same as 2.2 | |
| | | Level 2b: Same as | |
| | | Level 2a | |
| 2.4 Pₐ-I | Level 2b: Same as 2.2 | Level 1: Same as 2.1 | |
| | | Level 2a: Same as 2.2 | |
| | | Level 2b: Same as | |
| | | Level 2a | |

TABLE 3
Non-validation node for General category

| Type of | Level of Nodes | | |
|---|---|---|---|
| Interactions | Local | Regional | Global |
| 2.1 Pₐ₁-Pₐ₂ | Level 2b: At this | Level 1: For interactions of | Not required if the |
| | level, a non-validation | all types, the non-validation | global institution is the |
| | node could be an | node would be a node | only institution of its |
| | institution with | operated by an institution | type among the |
| | monetary or fiscal | with supervisory fiscal | participants. |
| | supervisory authority | and/or monetary authority | The institutions with |
| | in the fiscal | over the regional industry | weightage lesser than |
| | jurisdiction. | consortium. | a mutually agreed |
| | | Level 2a: | upon threshold can |
| | | For interactions of all types, | serve as non-validating |
| | | the non-validation node | nodes. |
| | | would be a node operated | |
| | | by an institution with | |
| | | supervisory authority over | |
| | | the regional groups. | |
| | | Level 2b | |
| | | For interactions of all types, | |
| | | the non-validation node | |
| | | would be a node operated | |
| | | by an institution with | |
| | | supervisory authority over | |
| | | the super-groups (i.e. | |
| | | regulatory networks) the | |
| | | regional groups are aligned | |
| | | to. | |
| 2.2 Pₐ-P_{b} | Level 2b: Same as | Level 1: Same as 2.1 | |
| | 2.1 | Level 2a: Same as 2.1 | |
| | | Level 2a: Same as 2.1 | |
| 2.3 Pₐ-G | Level 2b: Same as | Level 1: Same as 2.1 | |
| | 2.1 | Level 2a: Same as 2.1 | |
| | | Level 2a: Same as 2.1 | |
| 2.4 Pₐ-I | Level 2b: Same as | Level 1: Same as 2.1 | |
| | 2.1 | Level 2a: Same as 2.1 | |
| | | Level 2a: Same as 2.1 | |

Pₐ: Private Institution (Large/Reputed),
P_{b}: Private Institution (MSME),
G: Govt Institution,
I: Intergovernmental Institution
Pₐ₁-Pₐ₂: interactions between nodes operated by large privately owned institutions in the same industry, but different P2P distributed networks. For example the branch networks of 2 different banks.
Pₐ-P_{b}: interactions between nodes operated by a large privately owned institution, and an MSME institution. For example a privately owned bank and a cooperative bank or a Non-Banking Finance Company (NBFC).
Pₐ-G,: Interactions between nodes operated by a large privately owned institution, and a Government institution. For example a privately owned bank and a central bank.

For Low value transactions, to identify the validating node in heterogeneous network, Type 2 (General Category) model is followed with the following caveats:
1. The number of such transactions that shall be handled by the node in a specified time interval that can be a fixed threshold, N.
2. The transactions that need to be validated can be chosen by employing a sampling mechanism.
3. It might also be specified in a contract clause governing the transaction, that it be mandatorily notarized, by a specified node. Such transactions then need to be notarized over and above the caveats 1 & 2.

For High value transactions, to identify the validating node in heterogeneous network, Type 2 (General Category) model is followed, with additional notarization required in the following cases:
1. Specific type of transactions, wherein the node specifies the additional nodes required for such type.
2. Contract clause might specify additional notaries over and above the default ones.

### Other Unit(s) 618

In an embodiment, other unit(s) 618 may be configured to transmit the obtained consensus to one or more nodes of the network such as but not limited to non-participant node to inform about a set of rules governed by one or more institutions or the selected consensus mechanism, where the transmission may be performed over a data communication channel.

In this manner, the present disclosure provides a mechanism to obtain a consensus between the nodes of the network, particularly regulation for distribution of the resources. With the appropriate selection of the consensus mechanism, contention between nodes of the network is managed in the most effective manner and overall throughput gets increased. In addition, the consensus is obtained based on the attributes such as the security and privacy, thus enabling effective communication. Further, the proposed system may reduce operational overheads i.e. cost and time involved in resource exchange and provide flexibility in reconciling security and throughput in accordance with transaction contexts, thereby facilitating efficient communication.

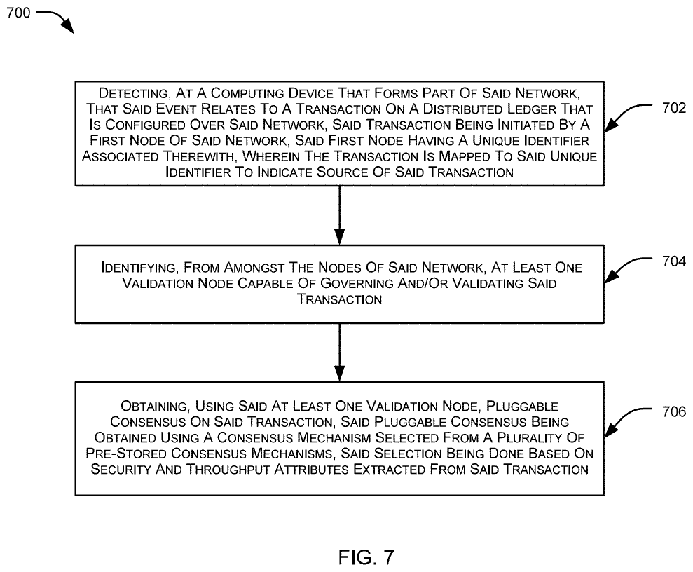

FIG. 7 illustrates an exemplary method for obtaining an consensus between nodes in a network, in accordance with an embodiment of the present disclosure.

In an embodiment, at block 702, said event relates to a transaction may be detected on a distributed ledger, at a computing device that forms part of said network. The event may be related to a transaction on a distributed ledger that is configured over said network. The transaction may be initiated by a first node of said network, whereas the first node having a unique identifier associated therewith. The transaction is mapped to said unique identifier to indicate source of said transaction.

At block 704, at least one validation node may be identified, from amongst the nodes of said network. The at least one validation node may be capable of governing and/or validating said transaction. At block 706, an pluggable consensus on said transaction may be obtained using said at least one validation node. The pluggable consensus may be obtained using a consensus mechanism selected from a plurality of pre-stored consensus mechanisms. In an embodiment, the plurality of the consensus mechanism may be stored in a database. The selection of the particular consensus mechanism to obtain the pluggable consensus may be performed based on security and throughput attributes extracted from said transaction.

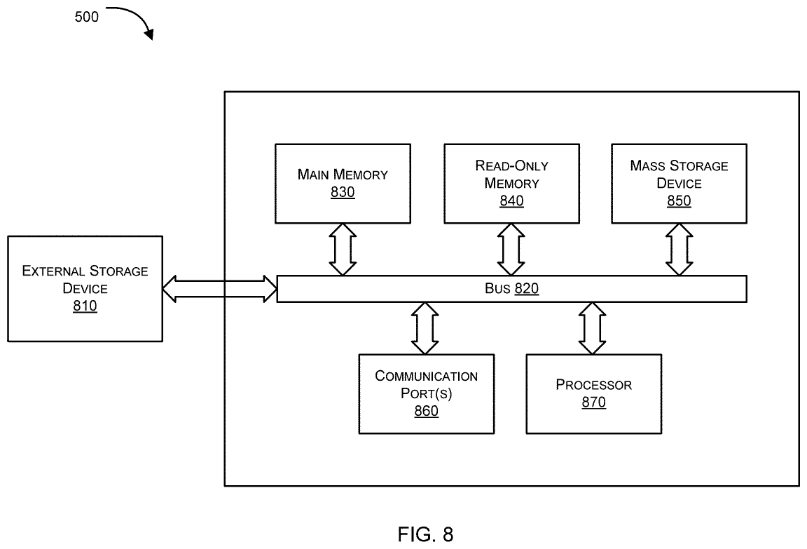

FIG. 8 illustrates an exemplary computer system 800 to implement the proposed system in accordance with embodiments of the present disclosure.

As shown in FIG. 8, computer system can include an external storage device 810, a bus 820, a main memory 830, a read only memory 840, a mass storage device 850, communication port 860, and a processor 870. A person skilled in the art will appreciate that computer system may include more than one processor and communication ports. Examples of processor 870 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 870 may include various modules associated with embodiments of the present invention. Communication port 860 can be any of an RS-232 port for use with a modem based dialup connection, a 10/100 Ethernet port, a Gigabit or 10 Gigabit port using copper or fiber, a serial port, a parallel port, or other existing or future ports. Communication port 860 may be chosen depending on a network, such a Local Area Network (LAN), Wide Area Network (WAN), or any network to which computer system connects.

Memory 830 can be Random Access Memory (RAM), or any other dynamic storage device commonly known in the art. Read only memory 840 can be any static storage device(s) e.g., but not limited to, a Programmable Read Only Memory (PROM) chip for storing static information e.g., start-up or BIOS instructions for processor 870. Mass storage 850 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7102 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 820 communicatively connects processor(s) 870 with the other memory, storage and communication blocks. Bus 820 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 870 to software system.

Optionally, operator and administrative interfaces, e.g. a display, keyboard, and a cursor control device, may also be coupled to bus 820 to support direct operator interaction with computer systems. Other operator and administrative interfaces can be provided through network connections connected through communication port 860. External storage device 810 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claim.

In the foregoing description, numerous details are set forth. It will be apparent, however, to one of ordinary skill in the art having the benefit of this disclosure, that the present disclosure can be practiced without these specific details. In some instances, well-known structures and devices are shown in block diagram form, rather than in detail, to avoid obscuring the present invention.

While the foregoing describes various embodiments of the disclosure, other and further embodiments of the disclosure may be devised without departing from the basic scope thereof. The disclosure is not limited to the described embodiments, versions or examples, which are included to enable a person having ordinary skill in the art to make and use the disclosure when combined with information and knowledge available to the person having ordinary skill in the art.

### Advantages of the Invention

The present disclosure provides an efficient mechanism to deploy consensus algorithms depending on the context of transactions.

The present disclosure provides a system for obtaining consensus between different nodes of the network reconciling privacy and security in both heterogeneous and homogeneous networks, thereby enabling effective communications.

The present disclosure provides a system that reduces operational overheads i.e. cost and time involved in resource exchange and provides flexibility in reconciling security and throughput in accordance with transaction contexts, thereby facilitating efficient processing of transactions.

The present disclosure provides a platform where the different nodes can interact with each other, thereby enabling resource exchange at global level (e.g., different nation states or associations of nation states groups) and/or regional level (formally defined groups such as economic coalitions) and/or local level (e.g., intracity and intercity).

I/We claim:

1. A system for obtaining consensus on an event between nodes of a network, said system being configured in at least one network device having a processor, said processor, through execution of instructions stored in an operatively coupled memory, being configured to:
detect that said event relates to a transaction on a distributed ledger that is configured over said network, said transaction being initiated by a first node of said network, said first node having a unique identifier associated therewith, wherein the transaction is mapped to said unique identifier to indicate source of said transaction;
identify, from amongst the nodes of said network, at least one validation node capable of governing and/or validating said transaction; and
obtain, using said at least one validation node, pluggable consensus on said transaction, said pluggable consensus being obtained using a consensus mechanism selected from plurality of pre-stored consensus mechanisms, said selection being done based on security and throughput attributes extracted from said transaction.

2. The system as claimed in claim 1, wherein said consensus mechanism is selected from any or a combination of BFT, PBFT, BFT-SMaRT, HotStuff, and SMR.

3. The system as claimed in claim 1, wherein said at least one validation node is identified based on geographical attributes associated with said transaction.

4. The system as claimed in claim 1, wherein said at least one validation node is identified based on volume of transactions initiated by said source, or volume of transactions that said source is part of.

5. The system as claimed in claim 1, wherein said at least one validation node is identified based on a number of nodes that form part of, or get impacted by said transaction.

6. The system as claimed in claim 1, wherein said at least one validation node is identified based on trust between nodes that form part of said transaction.

7. The system as claimed in claim 1, wherein said at least one validation node is selected from a plurality of validation nodes configured in the network, said plurality of validation nodes being configured in a hierarchical architecture so as to be used to validate/govern a plurality of transactions based on attributes of said transactions.

8. A method for obtaining consensus on an event between nodes of a network, said method comprising the steps of:
detecting, at a computing device that forms part of said network, that said event relates to a transaction on a distributed ledger that is configured over said network, said transaction being initiated by a first node of said network, said first node having a unique identifier associated therewith, wherein the transaction is mapped to said unique identifier to indicate source of said transaction;
identifying, from amongst the nodes of said network, at least one validation node capable of governing and/or validating said transaction; and
obtaining, using said at least one validation node, pluggable consensus on said transaction, said pluggable consensus being obtained using a consensus mechanism selected from plurality of pre-stored consensus mechanisms, said selection being done based on security and throughput attributes extracted from said transaction.

9. The method as claimed in claim 7, wherein said consensus mechanism is selected from any or a combination of BFT, PBFT, BFT-SMaRT, HotStuff, and SMR.

10. The method as claimed in claim 7, wherein said at least one validation node is identified based on geographical attributes associated with said transaction.

11. The method as claimed in claim 7, wherein said at least one validation node is identified based on volume of transactions initiated by said source, or volume of transactions that said source is part of.

12. The method as claimed in claim 7, wherein said at least one validation node is identified based on a number of nodes that form part of, or get impacted by said transaction.

13. The method as claimed in claim 7, wherein said at least one validation node is identified based on trust between nodes that form part of said transaction.

14. The method as claimed in claim 7, wherein said at least one validation node is selected from a plurality of validation nodes configured in the network, said plurality of validation nodes being configured in a hierarchical architecture so as to be used to validate/govern a plurality of transactions based on attributes of said transactions.
